(19) United States
(12) Patent Application Publication
(10) Pub. No.: US 2014/0255581 A1
(43) Pub. Date: Sep. 11, 2014

(54) Low Calorie Sugar Substitute Composition and Methods for Making the Same

(71) Applicant: Sioux Naturals, LLC, Sioux City, IA (US)

(72) Inventor: Paula Persinger, Sioux City, IA (US)

(73) Assignee: Sioux Naturals, LLC, Sioux City, IA (US)

(21) Appl. No.: 14/201,432

(22) Filed: Mar. 7, 2014

Related U.S. Application Data
(60) Provisional application No. 61/773,978, filed on Mar. 7, 2013.

(51) Int. Cl. A23L 1/236

(52) U.S. Cl. CPC A23L 1/2364
USPC 426/548

(57) ABSTRACT

The present invention is a low calorie sugar substitute composition that provides similar properties, characteristics, and taste of sugar at equivalent volumes and/or weights but without the calorie content of sugar or effects on glycemic index and a process for making the same.

### CROSS-REFERENCE TO RELATED APPLICATION(S)

This application claims priority from U.S. Provisional Application Ser. No. 61/773,978, filed Mar. 7, 2013.

### FIELD OF THE INVENTION

The present invention relates to a low calorie sugar substitute that can be substituted for sugar at a weight-to-weight and/or volume-to-volume basis, and the processes for making the same.

### BACKGROUND OF THE INVENTION

The present invention relates to a negligible calorie sugar substitute that can be substituted at a volume-to-volume basis, and processes for making the same. The preparation of cakes, cookies, ice cream, puddings, and other solid and semi-solid foods that have a significantly reduced calorie content and which retain the quality of conventional foods and beverages has been an elusive goal. Sugars such as sucrose, corn sweeteners, honey and the like play a variety of roles in food compositions, and thus a low calorie substitute most provide more than just sweetness. For instance, in addition to sweetness, sugar provides bulk, through the immobilization of water, it reduces the water activity in baked goods, it acts as a humectant to thereby affect the moisture of the finished product, and it affects the gelatinization temperature of starches during baking, and thereby plays a significant role in the structure, volume, and tenderness of the finished product. In ice cream, sugar provides texture, viscosity, mouthfeel, and freezing point depression. In semi-solid food compositions, sugar contributes to the basic texture of the product. Sugar is also an important browning agent during baking and other applications involving the application of heat. When mixed with fat sugar acts as a creaming agent, such as in custards. Sugar also can act as a foaming and stabilizing agent, such as with egg whites in a meringue.

Existing artificial sweeteners lack many of the above properties found in sugar. Further, the intensity of the sweetness of currently marketed sweeteners is much higher than that of sugar. Therefore the amount of artificial sweetener required to replace sucrose in a recipe will be significantly less and require substantial amounts of trial and error to determine the correct amount. And even when the correct amount to replicate sweetness is found, the above noted properties of sugar will still be lacking. Additionally, the taste of artificial sweeteners can often be different from that of sugar, frequently having a bitter aftertaste. There is a need in the art for a sugar substitute that provides similar properties and characteristics of sugar at equivalent volumes and/or weights but without the calorie content of sugar or effects on glycemic index.

### BRIEF SUMMARY OF THE INVENTION

A primary objective of the present invention is to provide a sugar substitute that provides similar properties, characteristics, and taste of sugar at equivalent volumes and/or weights but without the calorie content of sugar or effects on glycemic index.

A further objective of the invention is to provide a low calorie sugar substitute that can be used in recipes of all kinds without the need to adjust the amount of liquid used, temperatures applied, bake times, machines used, or viscosity.

A still further objective of the present invention is provide food compositions to people suffering from diabetes that will have minimal to no effect on blood sugar such that management of the disease condition becomes less burdensome.

A further objective of the present invention is to provide food compositions that do not promote tooth decay.

A still further objective of the current invention is to promote browning and crusting in a manner similar to sugar.

A further objective of the present invention is to provide a low calorie sugar substitute with heat stability similar to that of sugar.

A further objective of the present invention is to act as a creaming agent when combined with fat.

Another objective of the present invention is to act as a foaming agent when combined with eggs and to act as a stabilizing agent to said foam.

A still further objective of the present invention is to weaken gluten to create tenderness and fitness of texture during baking.

A further objective of the present invention is to retain moisture in a food composition during cooking or baking.

Still another objective is to provide a low calorie sugar substitute for brown sugar.

Yet another objective is to provide a low calorie sugar substitute for sugar syrup with comparable pourability and viscosity.

Another objective of the present invention is to provide a low calorie sugar substitute for powdered sugar or confectioners' sugar.

Disclosed herein is a low calorie sugar substitute composition comprising a sugar alcohol; a polymer of D-glucose; an oligosaccharide; and a high intensity sweetener wherein the sugar alcohol is selected from a group consisting of: sorbitol, mannitol, xylitol, erythritol, D-tagatose, isomalt (Palatinath), lactitol, maltitol, HSH (hydrogenated starch hydrolysates), Maltitol Syrups, or mixtures thereof.

Also disclosed herein is a is a low calorie sugar substitute composition comprising a sugar alcohol; a polymer of D-glucose; an oligosaccharide; and a high intensity sweetener wherein the oligosaccharide is selected from a group consisting of: fructooliosaccharide, maltodextrin, galactooligosaccharide, or mixtures thereof.

Also disclosed herein is a low calorie sugar substitute composition comprising a sugar alcohol; a polymer of D-glucose; an oligosaccharide; and a high intensity sweetener wherein the high intensity sweetener is selected from a group consisting of: aspartame, acesulfame-K, alitame, cyclamates, saccharin, sucralose, neohesperidin dihydrochalone, alitame, stevia sweeteners, glycyrrhizin, thaumatin, xylotol, extract of monk fruit, or mixtures thereof.

Disclosed herein is a process of making a low calorie sugar substitute comprising: selecting an amount of a sugar alcohol; selecting an amount of a polymer of D-glucose; selecting an amount of an oligosaccharide; selecting an amount of a high intensity sweetener; selecting an amount of an extract of monk fruit; blending a mixture of about 25% of the Polymer of Glucose with 100% of the high intensity sweetener; blending into said mixture 100% of the extract of monk fruit; blending into said mixture about 25% of the Polymer of Glucose; blending into said mixture about 50% of the total amount of the oligosaccharide; blending into said mixture the remaining amount of the Polymer of Glucose; and blending into said mixture the remaining amount of the oligosaccharide.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE FIGURES

FIG. 1 Shows a flow chart of the method of producing the low calorie sugar supplement according to certain embodiments.

FIG. 2 shows baking performance data in a yellow cake test.

FIG. 3 shows baking performance data in a angel food cake test.

FIG. 4 shows baking performance data in a chocolate chip cookie test.

### DETAILED DESCRIPTION

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

The term “baked goods” refers to all manner of foods which are cooked (i.e., prepared using heat). These baked goods include, but are not limited to, foods prepared using dry heat (i.e., a radiant or convection oven), fried foods, boiled foods and foods heated in a microwave oven.

The term “food compositions” refers to and includes all manner of viand (both sweetened and un-sweetened foods) for usage by man or animal. These food stuffs include, but are not limited to, baked goods, salted snacks, other flavored snacks, fruit drinks/mixes, frozen foods, candies, carbonated beverages, milk drinks/mixes, gelatins, puddings, fillings, breakfast cereals, breakfast bars, sauces, jams, jellies, whipped toppings, tablets, syrups, orally administered medicines, spreads, chewing gums and chocolates.

The term “low calorie sugar substitute” as used herein refers to a composition which is effective in replacing conventional sugars (i.e., sucrose, fructose, glucose, etc.) in food compositions and provides sugar-like functionality in the form of degree of hydration, viscosity, color, texture, odor, presentation and bulk, but with significantly reduced calories.

The term “monk fruit” as used herein refers to the fruit of the herbaceous perennial vine Siraitia grosvenorii, also known as luo han guo/luo han kuo.

The term “steviol glycosides” as used herein refers to compounds isolated from Stevia rebaudiana Bertoni, including but not limited to rabaudioside A, B, C, D, E, F, dulcoside A, and stevioside.

In one exemplary embodiment, the low calorie sugar substitute is comprised of an ingredient A, wherein ingredient A is a sugar alcohol; an ingredient B, wherein ingredient B is a polymer of D-glucose; an ingredient C, wherein ingredient C is an oligosaccharide; an ingredient D, where ingredient D is a high intensity sweetener; and ingredient E, wherein ingredient E is an extract of monk fruit.

In a further exemplary embodiment, ingredient A is present in amount between 44-54%; ingredient B is present in an amount between 25-35%; ingredient C is present in an amount between 17-21%; ingredient D is present in amount less than 1%; and ingredient E is present in an amount less than or equal to 1%.

In certain embodiments, ingredient D is present in amount less than 0.05%.

In certain embodiments, the low calorie sugar substitute is comprised of about 49% xylitol; about 30% polydextrose; about 19% fructooligosaccharide (FOS); about 0.05% or less steviol glycosides; and about 1% or less Monk Fruit extract.

In certain embodiments, the low calorie sugar substitute has the properties of promoting browning and crusting in a manner similar to sugar. In further embodiments, the low calorie sugar substitute has heat stability similar to that of sugar. In still further embodiments, the low calorie sugar substitute acts as a creaming agent when combined with fat. In yet further embodiments, the low calorie sugar substitute acts similarly to sugar in its performance as a foaming agent when combined with eggs and acts as a stabilizing agent to said foam. In further embodiments, the low calorie sugar substitute acts to weaken gluten to create tenderness and fitness of texture during baking In further embodiments, the low calorie sugar substitute acts to retain moisture in a food composition during cooking or baking. In further embodiments, the low calorie sugar substitutes has all of the forgoing characteristics and performs in a substantially similar manner to sugar in baking applications.

According to certain embodiments, the low calorie sugar provides similar properties, characteristics, and taste of sugar at equivalent volumes and/or weights but without the calorie content of sugar or effects on glycemic index. In certain embodiments, the low calorie sugar substitute contains about 1 calories per gram. In further embodiments, the low calorie sugar substitute can be substituted for sugar on a volume per volume/weight per weight basis. This allows for easy use of the low calorie sugar substitute in place of sugar in recipes without the need to adjust the amount of sweetener added or adjust amounts of other ingredients.

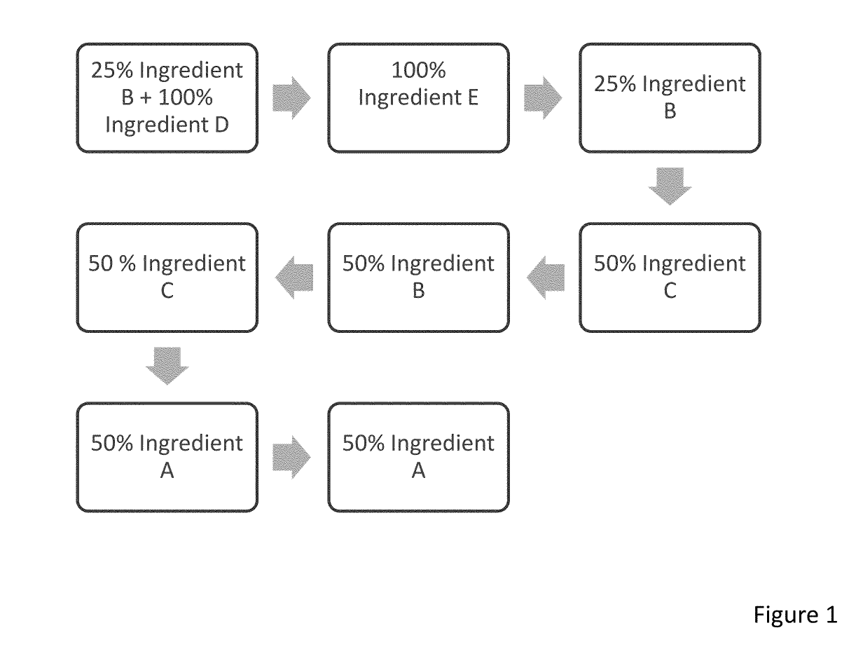

In other exemplary embodiments, the low calorie sugar substitute is made according to the following process as shown in FIG. 1.: 25% of the total amount ingredient B is blended with 100% of the total amount of ingredient D until ingredient D is fully incorporated. Next, 100% of the total amount of ingredient E extract is added and blended until fully incorporated into the composition mixture. Next, 25% of the total amount of ingredient B is added and blended until fully incorporated into the composition mixture. Next, 50% of the total amount of ingredient C is added and blended until fully incorporated into the composition mixture. Then the remaining 50% of the total amount of ingredient B is added and blended until fully incorporated into the composition mixture. Next, the remaining 50% of the total amount of ingredient C is added and blended until fully incorporated into the composition mixture. Next, 50% of the total amount of ingredient A is added and blended until fully incorporated into the composition mixture. Finally, the remaining 50% of the total amount of ingredient A is added and blended until fully incorporated into the composition mixture. In certain embodiments, 100% of ingredient A is added in a single step, but added slowly to ensure its incorporation into the mixtures as its added. This process and order of combing the ingredients results in a unique bonding of molecules that transforms the dust-like mixture into a crystal-like product, similar to the crystal-like structure of sucrose. One skilled in the art will recognize that blend times and speeds will vary according to the batch size of the low calorie sugar substitute being produced.

In certain embodiments, the product made according to the foregoing process has the properties of promoting browning and crusting in a manner similar to sugar. In further embodiments, the product made according to the foregoing process has heat stability similar to that of sugar. In still further embodiments, the product made according to the foregoing process acts as a creaming agent when combined with fat. In yet further embodiments, the product made according to the foregoing process acts as a foaming agent when combined with eggs and acts as a stabilizing agent to said foam. In further embodiments, the product made according to the foregoing process acts to weaken gluten to create tenderness and fitness of texture during baking. In further embodiments, the product made according to the foregoing process acts similar to sugar to retain moisture in a food composition during cooking or baking.

In yet another embodiment, the low calorie sugar substitute is a syrup. One skilled in the art will appreciate that a syrup can be made according to conventional methods. For example, in certain embodiments a syrup is made by combining the low calorie sugar substitute and water at a ratio of 1:1 ratio and providing heat until all solids have gone into solution.

In yet another embodiment, the low calorie sugar substitute is a substitute for brown sugar. In such an embodiment, the low calorie sugar substitute further comprises between 5-11% caramel, molasses, glycerin or alginates and natural flavors. In further embodiments, the low calorie sugar substitute for brown sugar further comprises about 1% mesquite pods. In certain embodiments, mesquite pods are added in addition to the between 5-11% caramel, molasses, glycerin or alginates and natural flavors. In further embodiments of the low calorie sugar substitute for brown sugar 1% mesquite pods are used in place of the between 5-11% caramel, molasses, glycerin or alginates and natural flavors.

In yet another embodiment the low calorie sugar substitute is a substitute for confectioners' sugar or powdered sugar. In such an embodiment, the normally crystalline form of the low calorie sugar substitute is pulverized to a 10×-16× finer powder. In this embodiment, the low calorie sugar substitute further comprises 3% starch, such as from rice, tapioca, corn or other sources, to prevent caking.

### EXAMPLES

The following constitute a representative sample of the numerous tests performed in establishing that the baking performance of the low calorie sugar substitute of the instant invention is substantially the same as sugar.

Yellow Cake

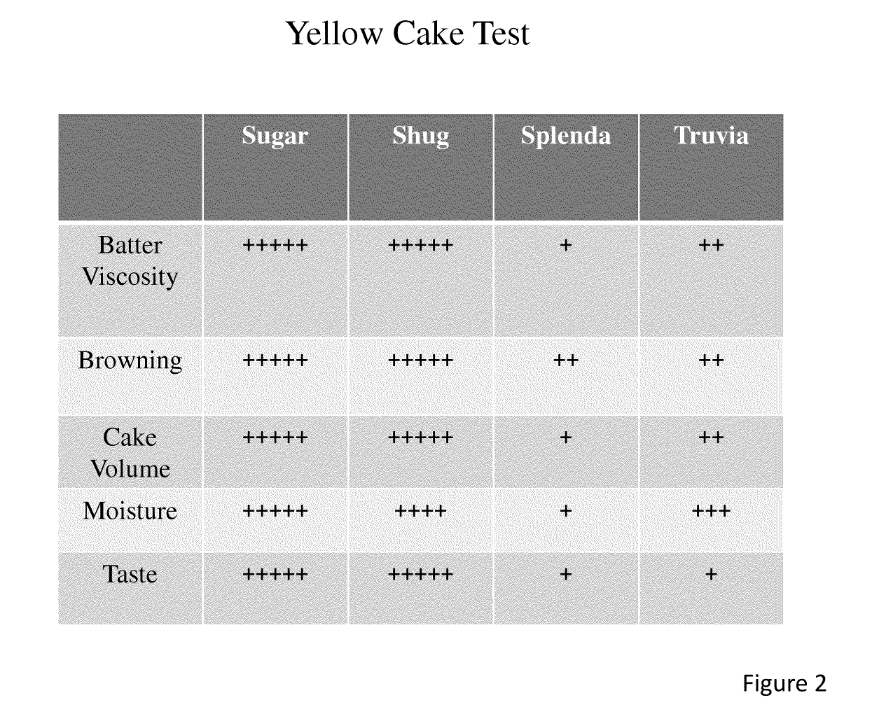

Low calorie sugar substitute was prepared as described above with a composition of 49% xylitol; 31.95% polydextrose; 19% fructooligosaccharide (FOS); and 0.05% steviol glycosides (hereinafter “Shug”). Four yellow cakes were prepared according to a standard recipe, 1 with each of the following: sugar, Shug, Splenda and Truvia. Cakes were rated according to the following qualities: Batter viscosity, cake volume, browning, moisture, and taste. Each category was rated on a scale of 1-5 with 5 being performance most like sugar and 1 being the least like sugar. Results are shown in FIG. 2. In all categories, Shug's performance was substantially the same as that of sugar. In contrast, Splenda and Truvia had substantially lower performance in each category.

Angel Food Cake

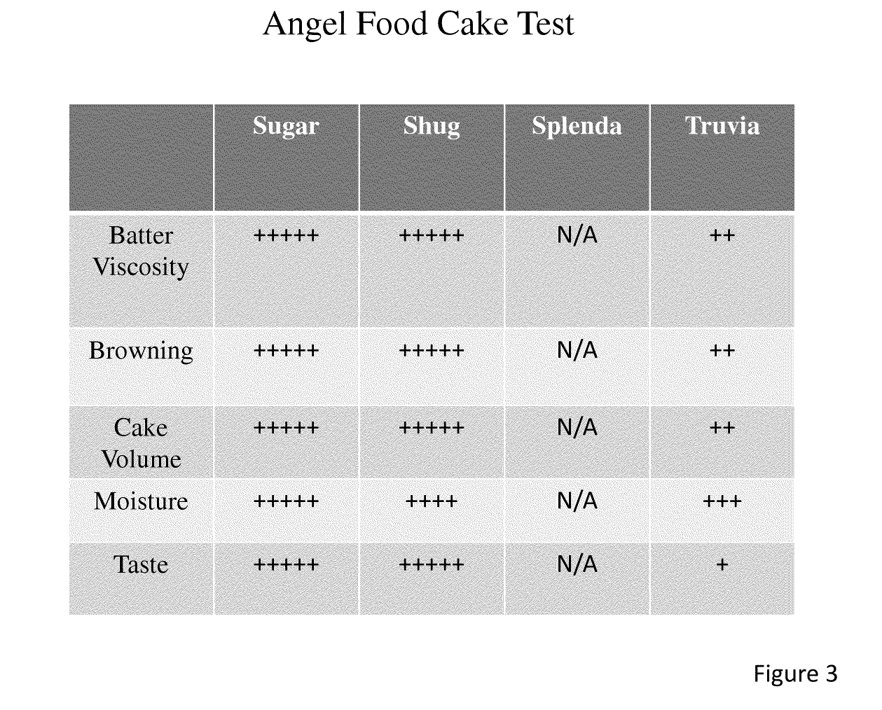

Four angel food cakes were prepared according to a standard recipe, one with each of the following: sugar, Shug, Splenda and Truvia. Cakes were rated according to the following qualities: batter viscosity, cake volume, browning, moisture, and taste. Each category was rated on a scale of 1-5 with 5 being performance most like sugar and 1 being the least like sugar. Results are shown in FIG. 3. In all categories, Shug's performance was substantially the same as that of sugar. The only category in which Shug differed was moisture which was slightly higher in the Shug cake. However, overall performance between sugar and Shug were substantially the same. In contrast, Splenda and Truvia had substantially lower performance in each category. With regard to Splenda, it failed to form a batter that allowed for ranking Accordingly, it is shown as N/A for each category.

Chocolate Chip Cookie

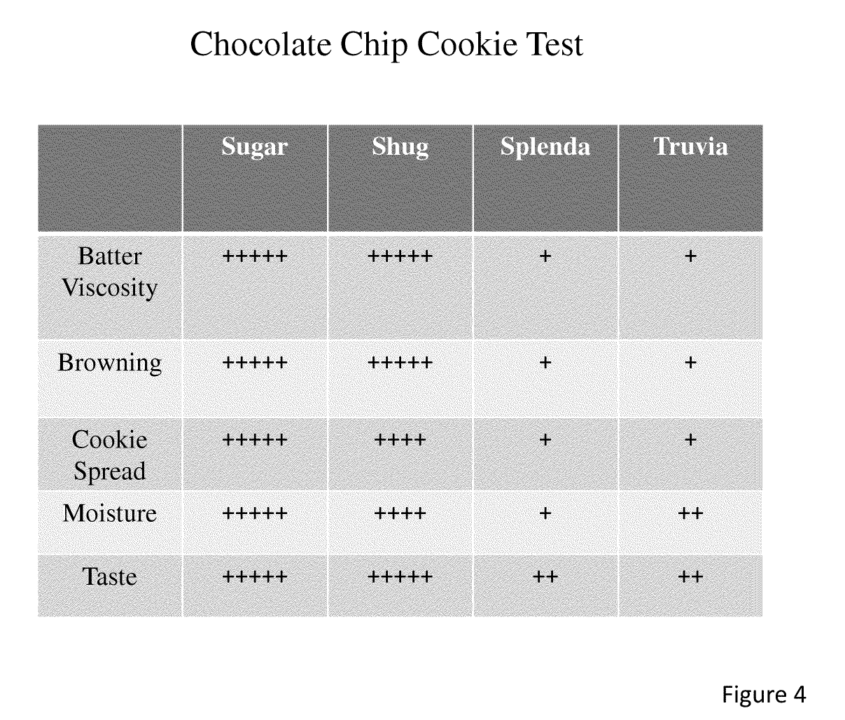

Four batches of chocolate chip cookies were prepared according to a standard recipe, one batch with each of the following: sugar, Shug, Splenda and Truvia. Cookies were rated according to the following qualities: batter viscosity, cookie spread, browning, moisture and taste. Each category was rated on a scale of 1-5 with 5 being performance most like sugar and 1 being the least like sugar. Results are shown in FIG. 4. In all categories, Shug's performance was substantially the same as that of sugar. In contrast, Splenda and Truvia had substantially lower performance in each category. With respect to cookie spread, Truvia had extensive spread that resulted in a thin dry cookie. Splenda yielded the opposite result with little to no spread and a highly dense cookie.

Although the present invention has been described with reference to preferred embodiments, persons skilled in the art will recognize that changes may be made in form and detail without departing from the spirit and scope of the invention.

What is claimed is:

1. A low calorie sugar substitute composition comprising:
a. a sugar alcohol;
b. Polymer of D-Glucose;
c. an oligosaccharide; and
d. a high intensity sweetener.

2. The composition of claim 1, wherein the sugar alcohol is selected from a group consisting of:
sorbitol, mannitol, xylitol, erythritol, D-tagatose, isomalt (palatinath), lactitol, maltitol, HSH (Hydrogenated Starch Hydrolysates), maltitol syrups, or mixtures thereof.

3. The composition of claim 1, wherein the oligosaccharide is selected from a group consisting of:
fructooliosaccharide, maltodextrin, galactooligosaccharide, or mixtures thereof.

4. The composition of claim 1, wherein the high intensity sweetener is selected from a group consisting of: aspartame, acesulfame-K, alitame, cyclamates, saccharin, sucralose, neohesperidin dihydrochalone, alitame, stevia sweeteners, glycyrrhizin, thaumatin, xylotol, extract of monk fruit or mixtures thereof.

5. The composition of claim 1 wherein the sugar alcohol is between about 44-55%; the polymer of D-glucose selected is between about 25-35%; the oligosaccharide is between about 17-21%; and the high intensity sweetener is about 0.05% or less.

6. The composition of claim 1 wherein the oligosaccharide is present in an amount from about 17 to 35%.

7. The composition of claim 1 wherein the high intensity sweetener is a plant based high intensity sweetener.

8. The composition of claim 1 wherein the low calorie sugar substitute is a substitute for brown sugar.

9. The composition of claim 8 further comprising between 5-11% caramel, molasses, glycerin or alginates and natural flavors.

10. The composition of claim 9 further comprising about 1% mesquite pod meal.

11. The composition of claim 1 wherein the low calorie sugar substitute is a substitute for confectioner's sugar.

12. The composition of claim 11 further comprising about 3% starch as an anti-caking agent.

13. The composition of claim 1 wherein the low calorie sugar substitute performs substantially the same as sugar in baking applications.

14. A process of making a low calorie sugar substitute comprising:
a. selecting an amount of a sugar alcohol;
b. selecting an amount of a polymer of glucose;
c. selecting an amount of an oligosaccharide;
d. selecting an amount of a high intensity sweetener;
e. blending a mixture of about 25% of the polymer of glucose with 100% of the high intensity sweetener;
f. blending into said mixture about 25% of the polymer of glucose;
g. blending into said mixture about 50% of the total amount of the oligosaccharide;
h. blending into said mixture the remaining amount of the polymer of glucose;
i. blending into said mixture the remaining amount of the oligosaccharide; and
j. blending into said mixture the entire amount of sugar alcohol.

15. The method of claim 14, wherein the sugar alcohol is selected from a group consisting of:
sorbitol, mannitol, xylitol, erythritol, d-tagatose, isomalt (palatinath), lactitol, maltitol, hsh (hydrogenated starch hydrolysates), maltitol syrups, or mixtures thereof.

16. The method of claim 14 wherein the amount of sugar alcohol selected is between about 44-55%; the polymer of D-glucose selected is between about 25-35%; the oligosaccharide selected is between about 17-21%; and the high intensity sweetener is about 0.05% or less.

17. The method of claim 14, wherein the oligosaccharide is selected from a group consisting of: fructooliosaccharide, maltodextrin, galactooligosaccharide, or mixtures thereof.

18. The method of claim 14, wherein the high intensity sweetener is selected from a group consisting of: aspartame, acesulfame-K, alitame, cyclamates, saccharin, sucralose, neohesperidin dihydrochalone, alitame, stevia sweeteners, glycyrrhizin, thaumatin, xylotol, extract of monk fruit or mixtures thereof.
